(19) United States
(12) Patent Application Publication
(10) Pub. No.: US 2010/0132800 A1
(43) Pub. Date: Jun. 3, 2010

(54) METHOD AND APPARATUS FOR CONTROLLING FLUCTUATIONS IN MULTIPHASE FLOW PRODUCTION LINES

(75) Inventors: Abul K. M. Jamaluddin, Kuala Lumpur (MY); Ifadat Ali Khan, Kuala Lumpur (MY); Andrew John Carnegie, Kuala Lumpur (MY)

Correspondence Address: Schlumberger Technology Corporation, P. O. Box 425045, Cambridge, MA, 02142, US

(73) Assignee: SCHLUMBERGER TECHNOLOGY CORPORATION, Cambridge, MA (US)

(21) Appl. No.: 12/325,503

(22) Filed: Dec. 1, 2008

(51) Int. Cl. F15D 1/02

(52) U.S. Cl. 137/2; 137/560

(57) ABSTRACT

Methods and apparatus for controlling the effects of slug flow in a flow line installation from a subterranean well to a production facility are described using in the flow line a flow conditioning unit, such as a flow booster and a flow choke, and a measuring device for measuring one or more parameter determined to be the most significant installation design or flow parameters correlated with the slug volume, connected to a control unit receiving input from the measuring device and using a relationship between slug volume and the one or more most significant parameters to control the flow conditioning unit.

### FIELD OF THE INVENTION

This invention is generally related to predicting, stabilizing or controlling slugging in multiphase flow, in particular in long flow lines (tiebacks) between subsea well heads and production facilities at the sea surface.

### BACKGROUND

Multiphase transport in long flow lines or pipelines from subterranean, particularly subsea wells to common production installations such as production systems, separators, risers, whether located subsea or at the surface or offshore or onshore, often shows a propensity to develop fluctuations, commonly referred to as slugs.

Slugs are assumed to be caused be gravity effects or hydrodynamical effects based on differences between the liquid and gaseous phases of the flow. Such effects lead typically to a localized accumulation of the liquid phase, i.e. a slug. In particular, liquid slugs are usually formed from flowing gaseous environment as a result of temperature and pressure decrease during the flow in production tubulars and/or flow lines

Slugging is by definition a transient phenomenon, and steady state conditions are hard to achieve in a slugging flow line system. Hydrocarbon liquid (alternatively water or a hydrocarbon/water mixture) accumulates along the production system and at some point reach the flow line exit. Between these slugs, there are periods where small amounts of liquid are exiting the system and the process will more or less receive a single gas phase, also described as gas slugs.

The instabilities caused by slug flow give rise to considerable problems in the well production facilities and operations of downstream processing plants. These problems include poor separation of water, oil and gas, overflow at the separator stages of the flow line, large and varied load on compressors and pumps, pressure variations in pipelines and marine risers resulting for example in non-optimal lifting operations.

At present, basically three methods are used in multiphase transportation systems in order to overcome process disturbances due to slugging. The first method is to reduce the flow rate and thereby the slug volumes within the limits of the downstream process, by throttling the (surface) inlet choke or by selecting a smaller flow line diameter in the design phase. The second method includes prolonging the start-up time or ramp up time when changing flow rates and the third method includes installing or increasing if possible the dimensions of the downstream process (i.e. slug catcher, alternatively the 1^{st} stage separator).

As described in the U.S. Pat. No. 7,434,621 to Aarvik and Uv and U.S. Pat. No. 7,239,967 to Havre, the method of choking the flow line to such extent that the operation point is outside the unstable flow regime has the severe disadvantage of decreasing the output flow to a level substantially lower than the capacity of the flow line. The '621 patent suggests therefore a system with a slug detector located downstream of the point for slug initiation and upstream of the process and a computer unit integrating the flow line system and the downstream process including software which determines the type of the slug, its volume and predicts its arrival time into the downstream process. The '967 patent describes a model-based feedback control system for stabilization of slug flow in multiphase flow lines and risers. The system consists of a single fast acting valve located at the outlet of the transport system, i.e. upstream of the separator. The opening of this valve is adjusted by a single output control signal from the feedback controller that uses continuous monitoring of pressure upstream of the point where slugs are generated as the main input parameter.

U.S. Pat. No. 5,256,171 to Payne and U.S. Pat. No. 5,544,672 to Payne et al. describe systems for mitigation of slug flow. Incoming slugs are detected inside the separation unit or upstream of the separator and a rough calculation of their respective volumes is performed. These slug volumes are thereafter compared with the liquid handling capacity of the separator. If the estimated volume of the incoming slugs exceeds the liquid slug handling capacity of the separator, a throttling valve located upstream of the separator is choked.

In view of the known art, it is seen as one object of the invention to provide methods and apparatus for predicting or mitigating the effects of slug flow without requiring complex slug detection methods or measurements at slug catcher or separator level. It is a particular object of the invention to provide such methods and apparatus for use or deployment between well head and riser in a marine or subsea installation.

### SUMMARY OF INVENTION

The invention as described in further detail below refers to a method of mitigating the effects of slug flow in a flow line installation for transport of a fluid from a subterranean well to a production facility by determining one or more most significant installation design or flow parameters correlated with slug volume; providing in the flow line a flow conditioning unit and a measuring device connected to a control unit for measuring the one or more flow related parameters; and using a relationship between slug volume and the one or more of the most significant parameters to control the flow conditioning unit.

Further aspects of the invention include an apparatus for mitigating the effects of slug flow in a flow line installation from a subterranean well to a production facility, the apparatus having within said flow line a flow conditioning unit and a measuring device for measuring one or more flow related parameters identified as being the most significant installation design or flow parameters correlated with the slug volume and control unit being programmed to implement a relationship between slug volume and the one or more of the most significant parameters to control the flow condition unit.

The most significant installation design or flow parameters correlated with the slug volume are preferably determined using experimental design methods and a simulation of the installation in question. Experimental design methods are established methods of testing the significance of test parameters for an output variable.

In a preferred variant of the invention, the measuring device is a flowmeter and the parameter is a flow rate of the flow, for example the total flow rate, and the flow conditioning unit includes a flow booster, such as a pump, and a flow choke. In other variants where, for example, heat transfer between the fluid and the environment is found to have a significant correlation with slug volume, the measuring device can be a thermometer or calorimeter and the flow condition unit may include a pipe heating or cooling system.

In another preferred variant of the invention, the control unit is operational without measurements performed at a slug catcher or separator unit. The term “operational” is defined herein as meaning being capable of performing the desired operation. The invention can thus be applied advantageously in subsea production facilities. The measuring device and the flow booster and choke can all be located subsea, preferably between the well and marine riser structure to prevent slugging going through the riser, thereby preventing for example a negative impact on gas lifting.

According to another aspect of the invention, the step of determining the most significant parameters can be applied to estimate the slug volume and design the volume of a slug catcher or separator unit accordingly.

In a preferred embodiment the controller maintains the flow rate in a band commensurate with the maximum volume of a slug catcher or separator unit.

In a preferred embodiment of the invention the power supply for the flow conditioning unit is provided via a power transmission cable from a subsea well head. The power can be electrical and/or hydraulic.

Further details, examples and aspects of the invention will be described below referring to the following drawings.

### BRIEF DESCRIPTION OF THE FIGURES

FIG. 1 illustrates a schematic implementation in accordance with an example of the present invention;

FIG. 2 is a Pareto chart showing the results of a Plackett-Burman experimental design;

FIG. 3 is a Pareto chart showing the results of full-factorial experimental design;

FIGS. 4A and 4B show a probability distribution for slug volumes as derived by Monte-Carlo simulation;

FIG. 5 compares results of the Monte-Carlo simulation of FIG. 4 with the results as derived from the experimental design;

FIG. 6 is a plot of relationships correlating flow rates and slug volumes for use in a control unit to mitigate slug flow; and

FIG. 7 is a plot of relationships correlating heat transfer and slug volumes for use in a control unit to mitigate slug flow.

### DETAILED DESCRIPTION

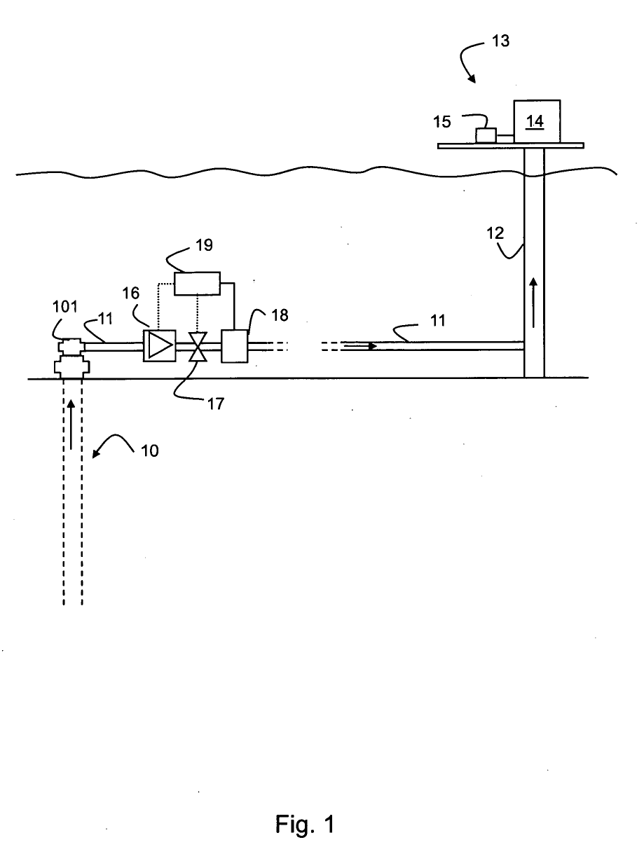

A typical subsea system is made up of a number of key components schematically illustrated in FIG. 1. Those components include a number of production and injection wells 10. These wells are then attached through flow lines 11 from the well head 101 to a riser 12 in which fluids are transported to the topsides production system 13. Typically as part of the surface installation 13 there are slug catcher or separator units 14 together with control and monitoring systems 15.

The reservoir fluid flowing in these flow lines could be gas, oil and/or water depending upon the characteristics of the reservoir, original fluid in the reservoir, design parameters of the flow lines/riser etc and some key flow parameters. The occurrence of slugging or slug flow in the installation is thought to be dependent on many design and flow parameters. There is hence currently no full analytical description of the process known.

In this example of the invention it is therefore proposed to first identify the most significant design and operating parameters affecting the slug volume in subsea gas condensate flow lines using for example experimental design and statistical analysis. Significant parameters identified using this methodology form the basis for flow assurance monitoring and surveillance but can also be used for running simulations with what-if scenarios at significantly reduced computational costs.

To identify the most significant parameters Plackett-Burman experimental design method is used in this example with six independent parameters, namely riser diameter, tieback length, pipe insulation/heat transfer, water depth, flow rate and fluid composition or condensate gas ratio (CGR) considering three levels for each parameter to test the nonlinearity of a dependent variable with respect to the considered “slug volume” (SGLV). The three levels of values are chosen from field exposure. Slug volume is calculated using a compositional hydrodynamic model as provided by the commercially available software PIPESIM™.

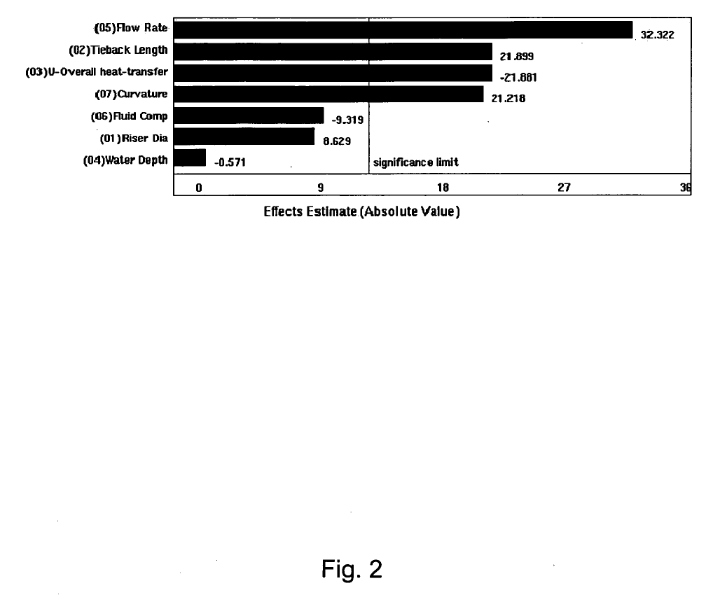

After changing some values of the parameter manually to remove unrealistic results for the slug volume used as analysis variable, a Pareto chart of standard effects at 95% confidence as shown in FIG. 2 is used to determine the most significant parameters in the simulation. These parameters are flow rate, tieback length, pipe insulation/heat transfer. However the curvature representing the non-linearity indicates that the relations between the parameters and the analytic variable SGLV are highly non-linear.

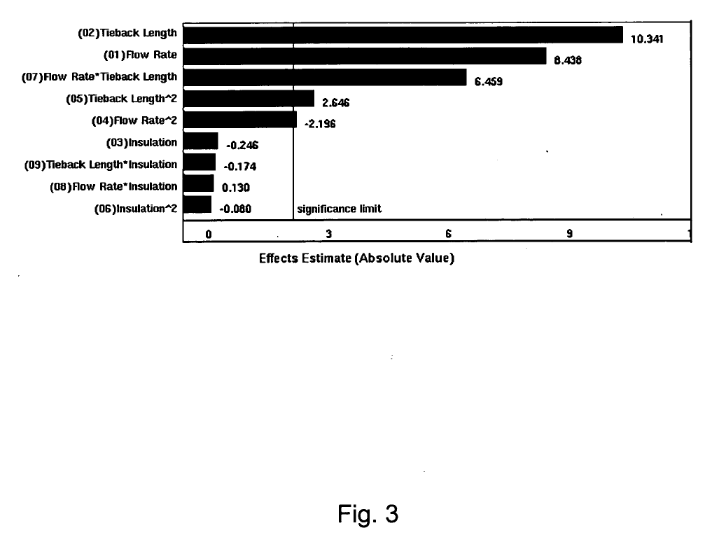

Due to nonlinearity further statistical analysis is used applying a full factorial experimental design restricted to the three most significant identified parameters as identified in the previous step, i.e. flow rate, tieback length and pipe insulation. With 27 simulation runs using three levels of settings for each variable (also dependent on the field exposure) a new Pareto chart is generated. The Pareto chart for these runs is shown in FIG. 3. It can be seen from the chart that only tieback length (which is usually fixed in the subsea installation) and flow rates are significant parameters for slug volume and that insulation is not a statistically significant parameter in this example.

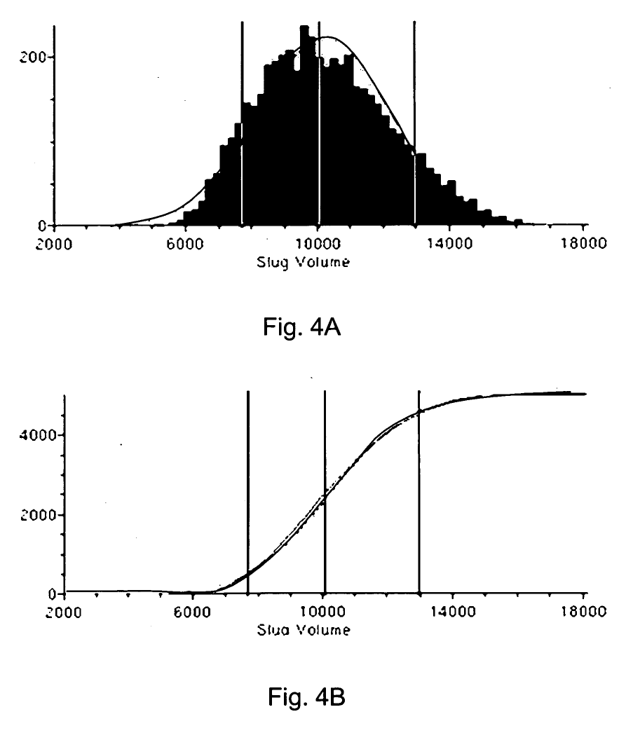

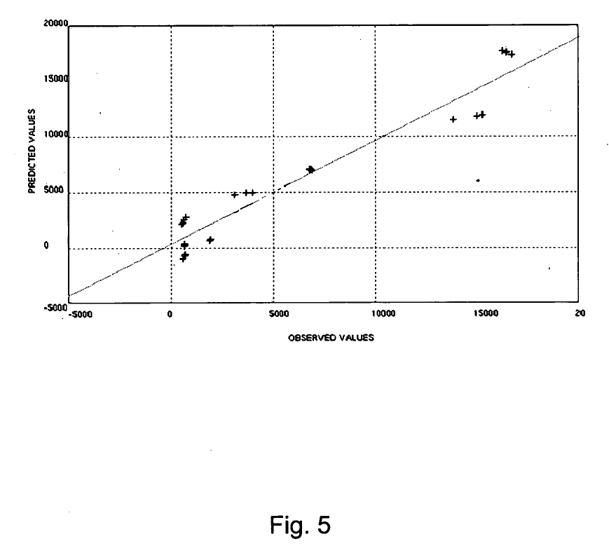

This result is confirmed by using a Monte-Carlo (MC) simulation on the design with 5000 different values of all six of the above parameters. The results of the MC simulation are shown in FIGS. 4A and 4B, which plots the slug volume distribution together with the P−10=7699 bbl, P−50=10061 bbl and P−90=12962 bbl values. These values can be used as design parameters when drafting the volume of a slug catcher 15 at the surface installation. In FIG. 5 the results of the simulation are plotted against the values of the slug volume as estimated by the experimental design in the previous steps. As shown, the best fit line through the scatter plot is close to the diagonal.

While providing constraints of the volume of a slug catcher, the above steps also form the basis of a control of the flow by providing the statistically relevant parameters, thereby constraining the control problem significantly. In the present example, the control problem is reduced from six possible parameters likely to influence the slug volume to one.

In addition to the mere identification of the relevant parameters, the simulation with experimental design provides a good approximation of the correlation or relation between any of these parameters and the slug volume. Thus a slug volume can be predicted from a measurement of the total flow rate alone without the need for additional measurements.

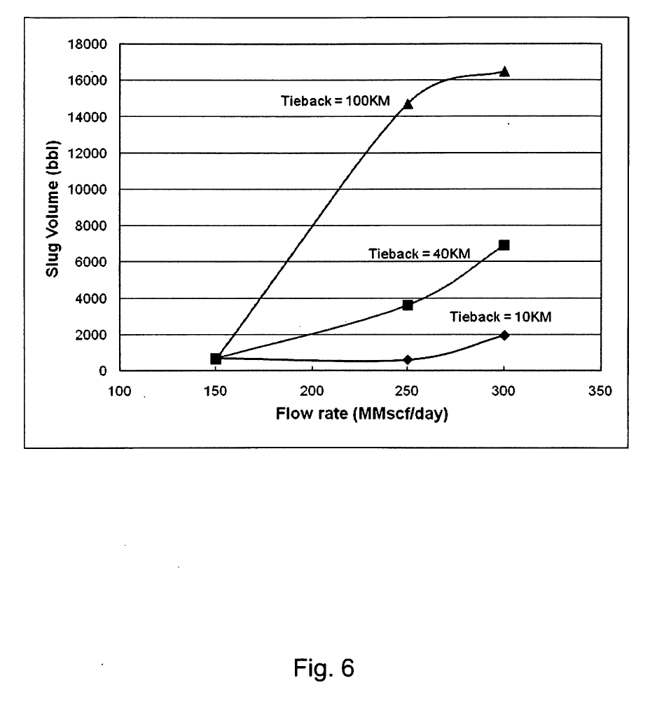

An example of a relationship derived by the above steps is shown in FIG. 6. This figure shows the relation between flow rate and slug volume for three different tie-back length (10 km, 40 km, 100 km) for an installation with a water depth of 5000 ft, a riser diameter of 16 inch and a CGR of 100. It is worth noting that the functions are neither linear in the flow rate nor in the tie back length. However, once determined the relationship between flow rate and the slug volume as shown can be used to control the slug size.

Referring back to the installation shown in FIG. 1, this example of the invention proposes a slug volume controller including a flow conditioning unit including a flow booster 16, a variable flow choke 17 and a flowmeter 18 at a location between well head and riser 12. In operation, a control unit 19 implementing a control function as shown in FIG. 6 (selected in accordance with the appropriate tie-back length) receives an input flow rate from the flow meter 18. The control unit 19 converts the flow rate into a predicted slug volume, and, dependent on the maximum volume as per the slug catcher facility 14, initiates a change of flow rate by either choking or boosting the flow.

The flowmeter 18 measures the total flow rate of all flow phases combined. Suitable flowmeters such as Schlumberger's PhaseWatcher™ are commercially available for subsea installation. The choke is preferably implemented as valve, while a subsea pump or gas lift can be used to boost the flow.

The flow conditioning unit of flowmeter flow booster 16, a variable flow choke 17 and a flowmeter 18 can be located close to the well head 101. At such a location power supply required for its operation can be tied to the power supplies for the well head 101, thus reducing the costs of the installation significantly. Alternatively, some or all parts of the unit can be placed close to the riser 18 or even form part of the surface installation 13.

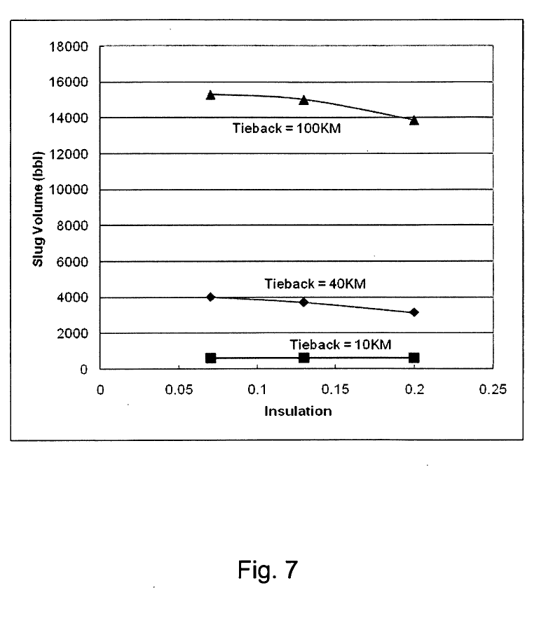

In principle it is possible to use parameters other than the flow rate to control the slug volume. The effect of pipe insulation or heat flow through the pipe wall on the slug volume as determined by experimental design is shown in FIG. 7. Though in this example the effect of heat flow is less significant than tieback length and flow rates, there may be cases where heat flow becomes significant. In such cases, the flow conditioning unit may include heating and/or cooling devices controlled through meters sensitive to the transfer of heat across the pipe wall. In other cases, further parameters may be identified as significant.

Hence the present example reduces the mitigation and control of slug flow to methods and apparatus which can implemented using a few commercially available components, avoiding complex feedback loops between control and measurements at the slug catcher or separation unit. The lack of such a feedback enables for example an installation close to a well head at locations distant from the production platform, where the effect of controlling the slug volumes is believed to have the highest impact.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative processes, one skilled in the art will recognize that the system may be embodied using a variety of specific procedures and equipment and could be performed to evaluate widely different types of applications and associated geological intervals. Accordingly, the invention should not be viewed as limited except by the scope of the appended claims.

What is claimed is:

1. A method of controlling the effects of slug flow in flow line installation from a subterranean well to a production facility, said method comprising the steps of
determining one or more most significant installation design or flow parameters correlated with the slug volume;
providing in said flow line a flow conditioning unit, a control unit and a measuring device for measuring said most significant installation design or flow parameters; and
using a relationship between slug volume and said one or more most significant parameters to control said flow conditioning unit.

2. The method of claim 1 wherein most significant installation design or flow parameters correlated with the slug volume are determined using experimental design methods and a simulation of the installation.

3. The method of claim 1 wherein the measuring device is a flowmeter and the parameter is a flow rate of the flow.

4. The method of claim 3 wherein the flow conditioning unit includes a flow booster and a flow choke.

5. The method of claim 1 being operational without measurements performed at a slug catcher or separator unit.

6. The method of claim 1 wherein the installation includes a subsea installation.

7. The method of claim 1 wherein the installation includes a subsea installation with a marine riser structure and the flow conditioning unit is located between the well and the marine riser structure.

8. The method of claim 1 wherein the flow conditioning unit is located in the vicinity of the well.

9. The method of claim 8 wherein the flow conditioning unit receives power from a power transmitter connected to a subsea well head.

10. An apparatus for mitigating the effects of slug flow in a flow line installation from a subterranean well to a production facility, said apparatus comprising in said flow line a flow conditioning unit, a measuring device for measuring one or more parameter identified as being the most significant installation design or flow parameters correlated with the slug volume, and a control unit, wherein said control unit is programmed to implement a relation between slug volume and said one or more of parameters to control the operation of said flow conditioning unit.

11. The apparatus of claim 10 wherein the flow conditioning unit comprises a flow booster and a flow choke.

12. The apparatus of claim 10 wherein the flow conditioning unit has a power transmission cable connected to a subsea well head.
